(19) United States
(12) Patent Application Publication
(10) Pub. No.: US 2008/0042371 A1
(43) Pub. Date: Feb. 21, 2008

(54) Gasket

(76) Inventor: Ralf Flemming, Langenbach (DE)

Correspondence Address: Robert L. Stearns;Dickinson Wright PLLC, 38525 Woodward Avenue, Suite 2000, Bloomfield Hills, MI, 48304, US

(21) Appl. No.: 11/720,086

(22) PCT Filed: Oct. 22, 2005
(86) PCT No.: PCT/DE05/01896

§ 371 Date: May 24, 2007

(30) Foreign Application Priority Data
Nov. 24, 2004 (DE) 10 2004 056 638.0

(51) Int. Cl. F16J 15/08; B21D 53/84

(52) U.S. Cl. 277/593; 29/888.3

(57) ABSTRACT

A flat seal, particularly for a cylinder head seal for use in internal combustion engines, containing at least one functional layer which is provided with at least one continuous opening and which is provided with at least one bead in the region of the continuous opening and which is connected in said region to at least one stopper element, particularly by means of welding, wherein the stopper element essentially corresponds to the contour of the bead and is positioned in the region of the bead, wherein the connection between the functional layer and the stopper element is provided radially to the rear of the bead in relation to the continuous opening.

The invention concerns a gasket, in particular a cylinder head gasket for internal combustion engines, containing at least one functional layer with at least one through-hole. In the area of the through-hole, the functional layer has at least one bead which is connected in this area with a stopper component, in particular through welding.

This type of gasket has already been published by e.g. DE -A 101 30 326, where the stopper component is shaped like a pair of spectacles and, as far as the through-holes are concerned, is radially connected with the functional layer behind the bead through welding.

DE -A 101 30 325 describes a single or multiple-layer gasket with at least one through-hole and, in the area of the through-hole, with at least one bead around the periphery and, in the area of the bead, with at least one moulded metal insert having a depression that accommodates the bead.

The underlying purpose of the invention is to provide an alternative gasket design with low stress in the area of the functional layer and the stopper component, particularly in cases where the gasket is re-formed. Furthermore, a production process for gaskets is proposed that avoids strains in the area of connection when the gasket is re-formed.

This task is solved by the stopper component largely following the contours of the bead and being positioned in the area of the bead, with the connection between the functional layer and the stopper element—in relation to the through-hole—being positioned behind the bead.

Further advantageous developments of the invention object can be gathered from the associated object sub-claims.

This task is also solved by the production process for a gasket (in particular a cylinder head gasket for an internal combustion engine) having at least one functional layer (with at least one through-hole) and at least one stopper component, whereby the stopper component is placed on the functional layer and joined with this in particular by welding and where, subsequently, functional layer and stopper component are re-formed to produce a bead in such a manner that the connection area between functional layer and stopper component—in relation to the through-hole—is positioned behind the bead.

Further advantageous developments of the invention-related process can be gathered from the associated process sub-claims.

If a stopper element is welded onto a functional layer and if both are subsequently re-formed there can ensue, as a result of the flow of material, shear stress to the area of connection if, as hitherto implemented, the area of connection is situated around the through-hole. In order to prevent this, the area of connection is located behind the bead, formed as a full bead for maximum advantage.

Furthermore, individual rings (stopper components) can be welded to the functional layer without a flange connection.

For maximum advantage the stopper component is shaped like spectacles, depending on the number of through holes.

The invention object is represented in the drawing by means of an execution example as in the following description. The following are illustrated:

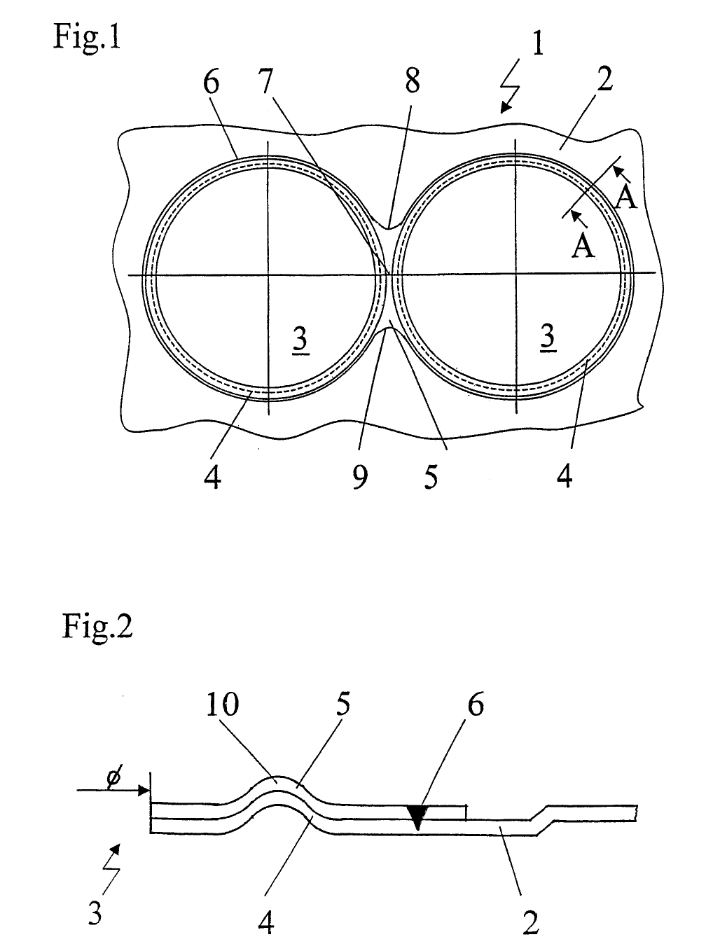

FIG. 1. Schematic diagram of a gasket for use as a cylinder head seal

FIG. 2. Sectional drawing along line A-A of FIG. 1.

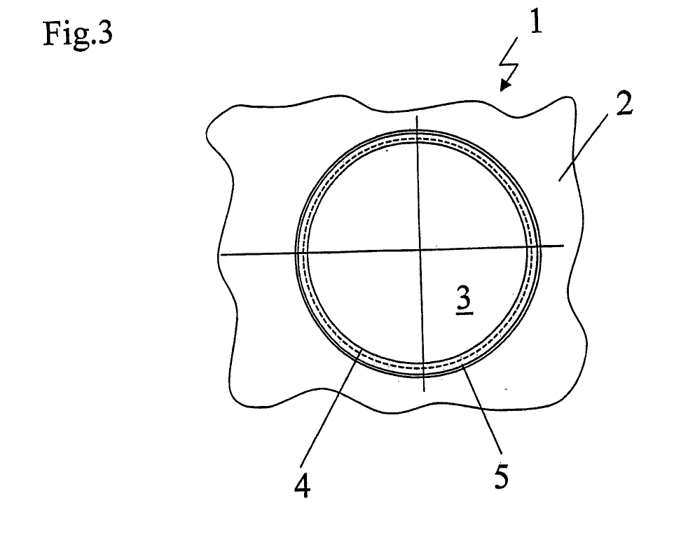

FIG. 3. Alternative cylinder head gasket

FIG. 1 shows a schematic diagram of cylinder head gasket 1 containing a functional layer 2 with several adjacent through-holes 3. Functional layer 2 has a bead 4 around the periphery in the area of the through-holes 3, with a stopper component 5 in the shape of a pair of connected spectacles being located below the bead 4, and each stopper component 5—in relation to the appropriate through-hole 3—is connected to the functional layer 2 by a radial welding seam 6 behind the bead 4. The welding seam 6 is produced by laser welding (laser spot welding). In this example the through-holes 3 are separated from each other by a narrow connecting bridge 7 so that each welding seam merges radially behind the beads 4 while forming opposing curvatures 8, 9.

FIG. 2 shows a sectional drawing along line A-A of FIG. 1. Discernible are functional layer 2, the stopper component 5, the bead 4, the implied through-hole 3 as well as the spot-welds 6. In accordance with the invention, the stopper component 5 also has a bead 10 in such a manner that it follows the contour of bead 4 formed as full bead, i.e. it is essentially seated without a gap.

The process for the production of the cylinder head gasket 1 is as follows: Functional layer 2 and stopper component 5, which start off as plane sheets, are positioned on top of each other, with the connection being effected by the spot welds 6 in such a manner that following a subsequent shaping of functional layer 4 (made of spring steel) as well as of the stopper component 5 located above it, on the one hand full beads 4 and 10 are formed, and on the other hand, following the re-forming, spot welds 6 are made radially behind beads 4, 10 in relation to the through-hole 3. This procedure ensures that in the process of re-forming and associated material flow no shear stress is exerted on the spot-welds.

FIG. 3 shows an alternative cylinder head gasket 1′ to that of FIG. 1. Discernible are the functional layer 2, through-hole 3 as well as bead 4. Stopper component 5′ is just implied and forms the only ring around through-hole 3. The cross-sectional form can be selected similar to FIG. 2.

1-9. (canceled)

10. A cylinder head gasket for an internal combustion engine, comprising:
at least one functional layer having at least one through-hole and at least one bead adjacent said through-hole;
a stopper component shaped to follow the contour of said at least one bead and welded to said at least one functional layer on a side of said at least one bead radially opposite said at least one through-hole.

11. The gasket of claim 10 wherein said at least one bead comprises a full bead and said stopper component includes a corresponding nested full bead.

12. The gasket of claim 11 wherein said full bead of said at least one functional layer and said corresponding nested full bead of said stopper component are sized and shaped such that there is essentially no gap between the beads.

13. The gasket of claim 11 wherein said weld comprises spot welds.

14. The gasket of claim 11 wherein said stopper component forms only one ring around said at least one through-hole.

15. The gasket of claim 11 wherein said stopper component is formed in the shape of spectacles.

16. A method of making a cylinder head gasket for an internal combustion engine, comprising:
preparing at least one functional layer with at least one through-hole,
preparing at least one stopper component;
welding the at least one stopper component to the at least one functional layer in a connection area; and
subsequently forming nested beads in the at least one functional layer and the at least one stopper component adjacent the at least one through-hole and radially inward of said welded connection area.

17. The method of claim 16, wherein the nested beads are formed as full beads.

18. The method of claim 16, wherein the welding comprises spot welding.
